(19) United States
(12) Patent Application Publication
(10) Pub. No.: US 2004/0034785 A1
(43) Pub. Date: Feb. 19, 2004

(54) Hardware and firmware encryption mechanism using unique chip die identification

(76) Inventors: Horng-Ming Tai, Plano, TX (US); Brian Tse Deng, Richardson, TX (US); Dinghui Richard Nie, Plano, TX (US)

Correspondence Address: TEXAS INSTRUMENTS INCORPORATED, P O BOX 655474, M/S 3999, DALLAS, TX, 75265

(21) Appl. No.: 10/219,361

(22) Filed: Aug. 15, 2002

(51) Int. Cl. G06F 12/14

(52) U.S. Cl. 713/189

(57) ABSTRACT

A method and system are provided to implement firmware encryption and decryption for firmware that must be downloaded from an external on-board ROM, for example, into the RAM of a controller IC. Encrypted firmware is provided using a combination of hardware, firmware and a unique on-chip serial number (die ID). The hardware and associated firmware are provided in a manner that does not require public and/or private keys. The encrypted firmware image is different for each end product such that a unique and unknown encryption key is generated for each end product.

### REFERENCE TO PROGRAM LISTING APPENDIX

A computer program listing appendix entitled “Appendix A—Encryption Instruction Controller Program Listing Including Encryption Portion of Boot Code File” is included herewith as part of this specification and incorporated by reference herein in its entirety.

### BACKGROUND OF THE INVENTION

1. Field of the Invention

This invention relates generally to firmware encryption and more specifically to a method of achieving firmware encryption using a unique chip die identification (ID) via associated hardware and software mechanisms.

2. Description of the Prior Art

Firmware is playing a more important role in today's electronic products. The functionality and behavior of many end products is controlled by both hardware and firmware. Developing a successful firmware is a major portion of the investment effort associated with product development costs. Protecting the firmware stored in any on-chip RAM and on-board EEPROM, for example, is an important aspect of a corporation's intellectual property.

When firmware is required to be downloaded from an external on-board ROM into the RAM of a controller integrated circuit (IC), the code can be easily read out by tapping into the data communication lines connected between the controller IC and its external EEPROM. This is undesirable since the firmware can then be revealed to business competitors.

It is therefore advantageous and desirable in view of the foregoing, to provide a method and system of implementing reliable firmware encryption and decryption for firmware that must be downloaded from an external on-board ROM into the RAM of a controller IC.

### SUMMARY OF THE INVENTION

The present invention is directed to a method and system of implementing firmware encryption for firmware that must be downloaded from an external on-board ROM, for example, into the RAM of a controller IC. One such application may include, for example, a universal serial bus (USB) to advanced technology attachment packet interface (ATAPI) bridge controller, among others.

According to one aspect of the invention, hardware and associated firmware is provided to achieve firmware encryption and decryption.

According to another aspect of the invention, firmware encryption and decryption is provided using a combination of hardware, firmware and a unique on-chip serial number (die ID).

According to yet another aspect of the invention, hardware and associated firmware is provided in a manner that does not require public and/or private keys.

According to still another aspect of the invention, hardware and firmware are provided to achieve firmware encryption without requiring knowledge about a key value.

According to still another aspect of the invention, hardware and firmware are provided to achieve firmware encryption in which the encrypted firmware image is different for each end product.

According to still another aspect of the invention, hardware and firmware are provided to achieve firmware encryption in which a unique and unknown encryption key is generated for each end product.

According to still another aspect of the invention, a single set of hardware and firmware are provided to achieve firmware encryption for any product that employs an on-chip boot code and an off-chip firmware stored in an on-board EEPROM or the like.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawing figures wherein:

FIG. 1 is a flowchart depicting a boot code encryption/decryption sequence;

FIG. 2 is a simplified logic diagram depicting a technique for generating a first private key suitable for use by the encryption/decryption sequence shown in FIG. 1;

FIG. 3 is a flowchart depicting initialization of a random key and byte array that is suitable for use by the method shown in FIG. 1;

FIG. 4 is a flowchart depicting a method of encryption byte swapping that is suitable for use by the method shown in FIG. 1;

FIG. 5 is a flowchart depicting a method of decryption byte swapping that is suitable for use by the method shown in FIG. 1;

FIG. 6 shows a table depicting eight shoes generated using the encryption sequence shown in FIG. 1;

FIG. 7 is a flowchart depicting a method for getting a random key and that is suitable for use by the method shown in FIG. 1;

FIG. 8 is a flowchart depicting a method of encryption that is suitable for use by the method shown in FIG. 1;

FIG. 9 is a flowchart depicting a method of decryption that is suitable for use by the method shown in FIG. 1;

FIG. 10 is a flowchart depicting a method of key rotation that is suitable for use by the method shown in FIG. 1;

FIG. 11 is a flowchart depicting an encryption state machine corresponding to the method of encryption shown in FIG. 1;

FIG. 12 is a schematic diagram illustrating encryption MCU address decode, read data mux, die ID scrambler, and key next value mux logic associated with the method of encryption shown in FIGS. 1-11;

FIG. 13 is a schematic diagram illustrating encryption key registers and function control register update and clear logic associated with the method of encryption shown in FIGS. 1-11; and

FIG. 14 is a schematic diagram illustrating operation registers logic and random operation mux select counter logic associated with the method of encryption shown in FIGS. 1-11.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

One embodiment of a bridge controller can include firmware stored in an external on-board ROM such as an EEPROM, for example, that is required to be downloaded into an on-chip RAM. This firmware can be easily but undesirably revealed by tapping into the data communication signal lines connected between the controller IC and its external EEPROM unless the firmware is encrypted.

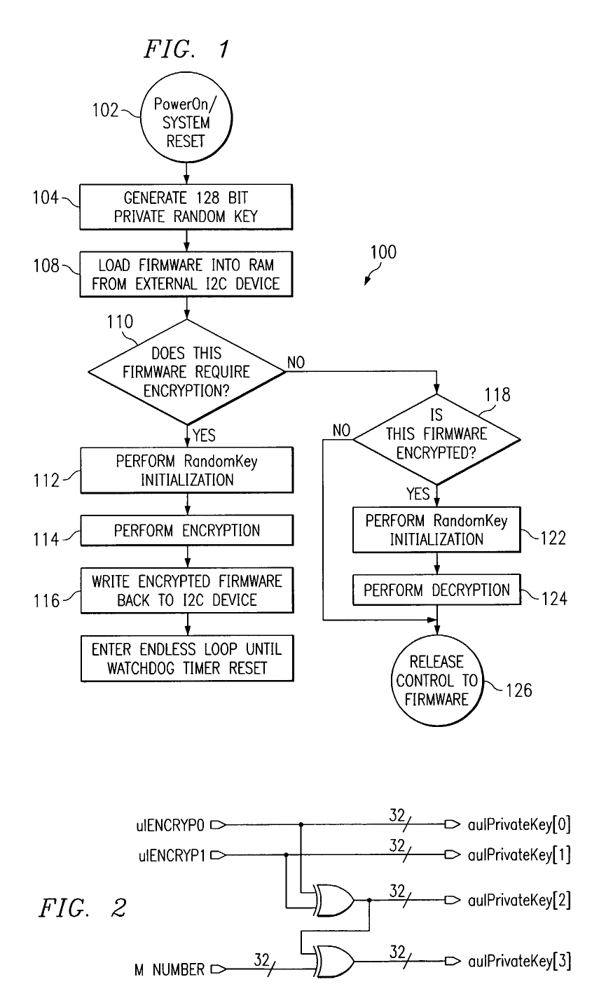

FIG. 1 is a flowchart depicting a boot code encryption/decryption sequence 100 that may be employed, for example, by a USB to ATAPI bridge controller, among other types of devices that employ an on-chip code and off-chip firmware stored in an on-board data storage device such as an EEPROM. The boot code encryption/decryption sequence 100 takes advantage of an on-chip die ID number that may comprise, for example, 64-bits, that is unique to each individual IC die. When the controller is powered-up for the first time at the end product manufacturing site, eight encryption key registers contain the unique 64-bit number based on the chip's die ID number with modification achieved by hardwired bit swapping and re-mapping. The USB-reset cannot reset this register. Table 1 below defines the eight encryption key registers as well as an encryption function control register associated with one USB to ATAPI bridge controller. The encryption key registers are eight-bit read only (R/O) registers in which each register contains its own unique byte value.

TABLE 1
Encryption Register Map

| Register Address | Register Name | Register Description |
|---|---|---|
| F0B4 | ENCRYP0 | Encryption Key Register 0 |
| F0B5 | ENCRYP1 | Encryption Key Register 1 |
| F0B6 | ENCRYP2 | Encryption Key Register 2 |
| F0B7 | ENCRYP3 | Encryption Key Register 3 |
| F0B8 | ENCRYP4 | Encryption Key Register 4 |
| F0B9 | ENCRYP5 | Encryption Key Register 5 |
| F0BA | ENCRYP6 | Encryption Key Register 6 |
| F0BB | ENCRYP7 | Encryption Key Register 7 |
| F0BC | ENCRYP_CTRL | Encryption Function Control |
| | | Register |

Table 2 below defines the encryption function control register. The encryption function control register is an eight-bit register in which all bits except bits 0, 1 and 3 are R/O bits. Bits 0 and 1 are read/write (R/W) bits.

The encryption ROTA16R procedure is a rotate 16-bit right once procedure such that when the micro-controller unit (MCU) sets OPMODE=01, hardware performs this “rotate right once” independent operation to each 16-bit segment stored in ENCRYP[1:0], ENCRYP[3:2], ENCRYP[5:4], and ENCRYP[7:6] registers. Subsequent to this operation, the original bit 0 in the ENCRYP0 register becomes bit 7 in the ENCRYP1 register. All other bits are rotated in the same manner.

The encryption ROTA16L procedure is a rotate 16-bit left once procedure such that when the MCU sets OPMODE=10, hardware performs this “rotate left once” independent operation to each 16-bit segment stored in ENCRYP[1:0], ENCRYP[3:2], ENCRYP[5:4], and ENCRYP[7:6] registers. Subsequent to this operation, the original bit 7 in the ENCRYP1 register becomes bit 0 in the ENCRYP0 register. All other bits are rotated in the same manner.

The encryption RKEYGEN procedure is a random key generation procedure such that when the MCU sets OPMODE=11, hardware performs the random key generation once based on the value stored in ENCRYP[3:0] and ENCRYP[7:4]. One encryption random key generation algorithm that is suitable for use with the boot code encryption/decryption sequence 100 is written as

ENCRYP]3:0]=ENCRYP[3:0]+ENCRYP[7:4]+

| | |
|---|---|
| (ENCRYP[3:0]<<3)+ | // 3 bit shift to the left |
| (ENCRYP[3:0]<<9)+ | // 9 bit shift to the left |
| 0x41C64E6D (constant). | |

TABLE 2
Encryption Function Control Register

| Bit | Name | Reset | Function |
|---|---|---|---|
| 1-0 | OPMODE [1:0] | 00 | Encryption Operation Modes |
| | | | MCU can write to these OPMODE bits to |
| | | | perform a particular encryption operation |
| | | | once. |
| | | | OPMODE = 00 No operation. |
| | | | OPMODE = 01 Perform ROTA16R |
| | | | operation. |
| | | | OPMODE = 10 Perform ROTA16L |
| | | | operation |
| | | | OPMODE = 11 Perform RKEYGEN |
| | | | operation |
| 2 | OPDONE | 0 | Encryption Operation Done status bit |
| | | | When set (OPDONE = 1), this read-only |
| | | | status bit indicates that the encryption |
| | | | operation specified in OPMODE is |
| | | | finished. MCU most preferably has to |
| | | | write a ‘1’ to this bit to clear it. |
| 3 | ENCRYDIS | 0 | Encryption Disable Bit. |
| | | | ENCRYDIS = 0 No operation. |
| | | | ENCRYDIS = 4 This bit, when set, |
| | | | hardware clears all the value stored in |
| | | | ENCRYP[7:0]registers and disables any |
| | | | further write access to these registers and |
| | | | this Encryption Function Control Register |
| | | | Any subsequent read to these registers |
| | | | returns a zero value. |
| 7-4 | RSV | 0 h | Reserved = 0 hex |

Looking again at FIG. 1, the boot code encryption/decryption sequence 100 can be seen to commence with a power-on/system reset 102. Subsequent to the power-on/system reset 102, a 128-bit private random key is generated as seen in block 104.

FIG. 2 is a simplified logic diagram depicting one technique that employs both hardware and firmware for generating the first private key suitable for use by the boot code encryption/decryption sequence 100 shown in FIG. 1. The M number is a 32-bit constant seed number used to generate the first 128-bit private key. Next, the firmware located in the external on-board EEPROM or other like storage device is downloaded into the on-chip RAM as shown in block 108, in response to the on-chip ROM based encryption/decryption boot code 100. Immediately following the firmware download shown in block 108, the downloaded firmware is examined to determine if the firmware requires encryption as seen in block 110. If encryption is required, then a random key initialization procedure is implemented as seen in bock 112.

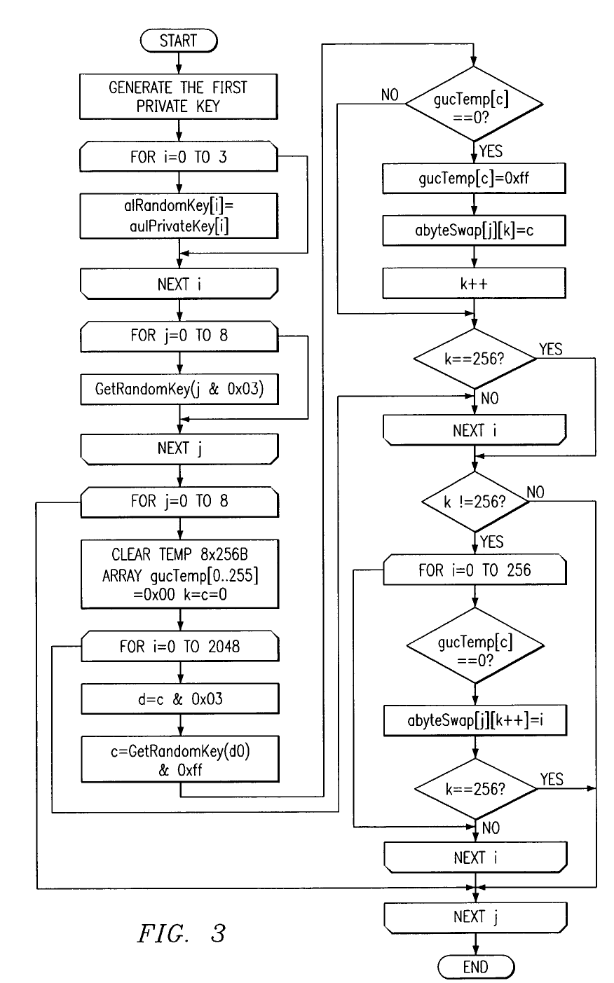

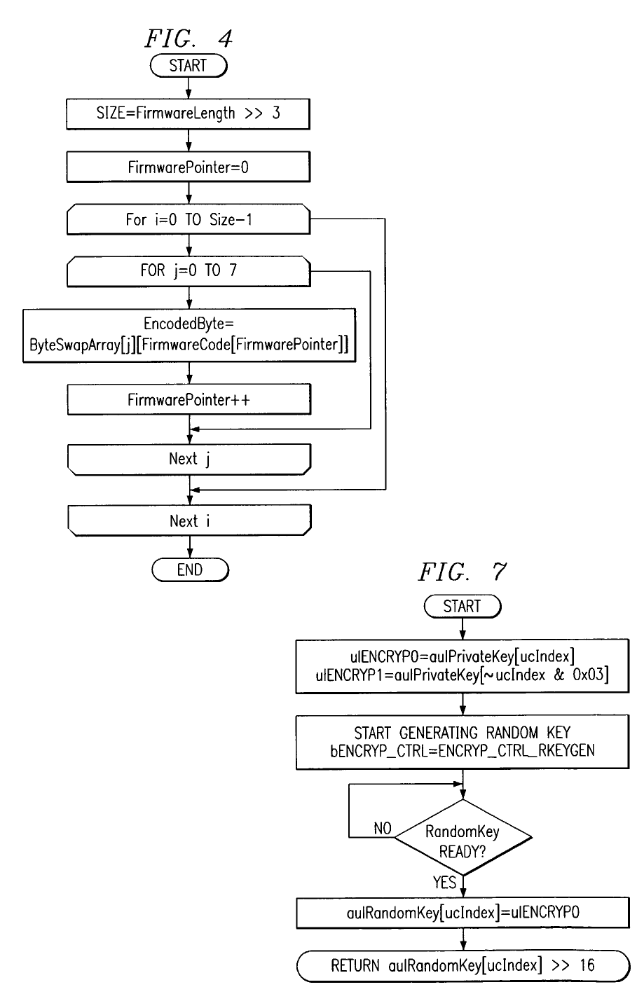

FIG. 3 is a flowchart depicting initialization of a random key and byte array that is suitable for use by the boot code encryption/decryption sequence 100 shown in FIG. 1. The random key and byte initialization procedure can be seen to employ byte swapping. One suitable byte swapping encryption procedure is shown in FIG. 4. Immediately following the random key initialization process, the desired encryption procedure is implemented as seen in block 114.

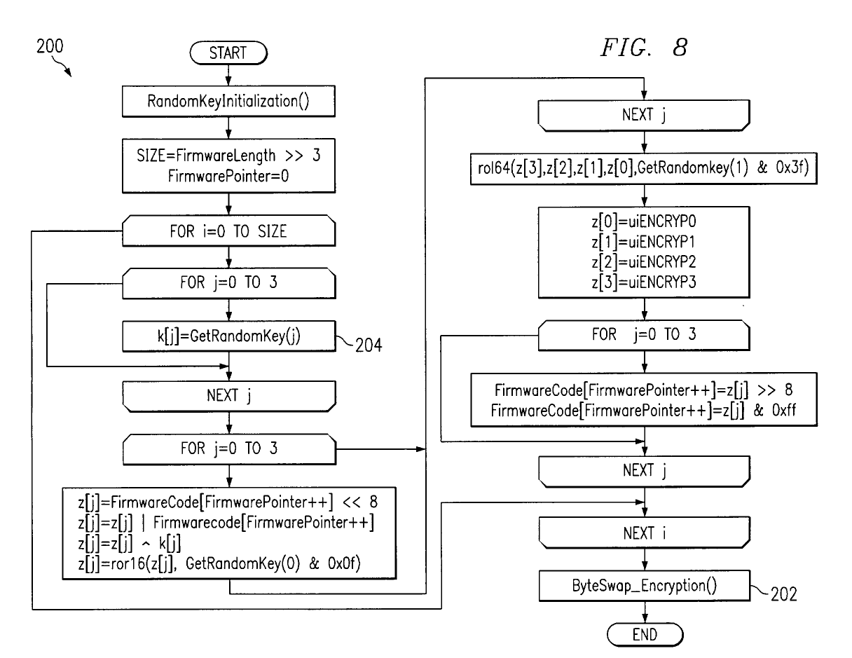

FIG. 8 is a flowchart depicting a method of encryption 200 that is suitable for use by the method shown in FIG. 1. The method of encryption 200 employs a byte swapping algorithm as seen in block 202. As stated herein before, FIG. 4 is a flowchart depicting one method of encryption byte swapping that is suitable for use by the method shown in FIGS. 1 and 8.

Encryption method 200 also employs a method to retrieve the private random key as seen in block 204. FIG. 7 is a flowchart depicting one method for getting a random key and that is suitable for use by the encryption method shown in FIGS. 1 and 8 respectively.

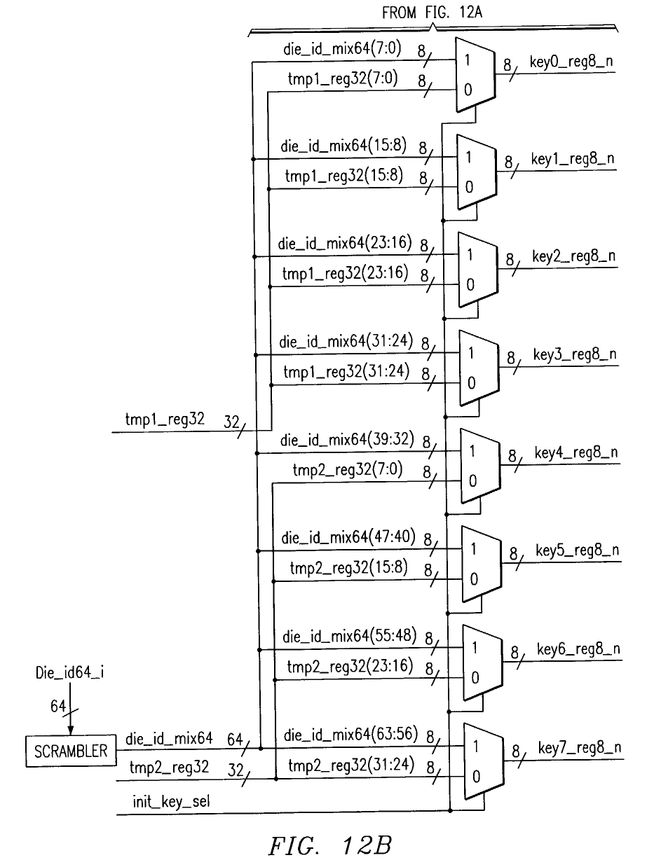

Encryption method 200 can also be seen to use the rotate key left and rotate key right techniques discussed herein before with reference to Table 2 above. FIG. 10 depicts a method of key rotation that is suitable for use by the method of encryption shown in FIGS. 1 and 8.

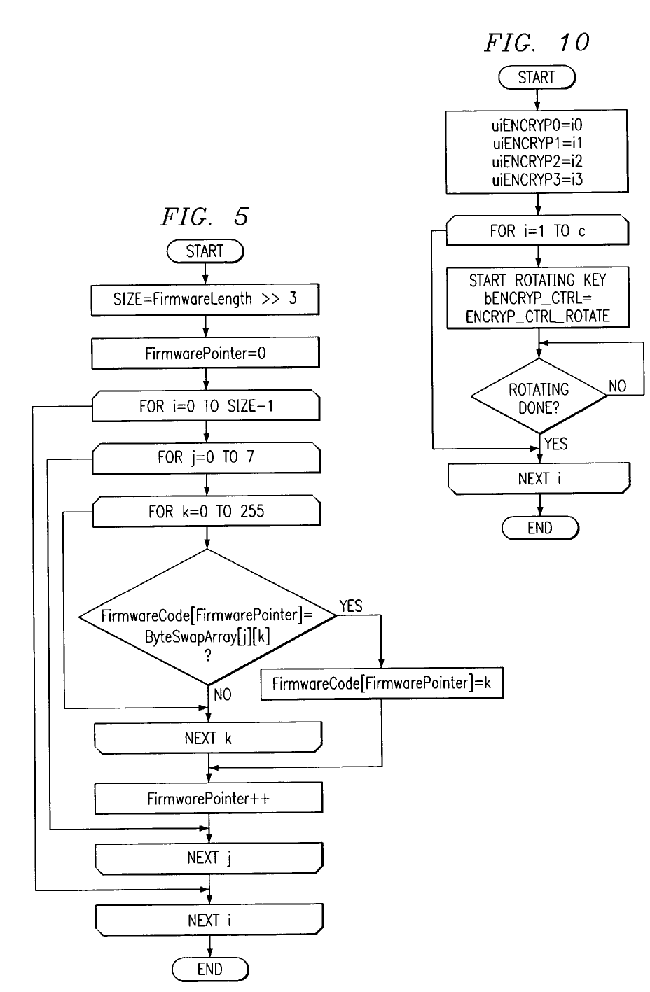

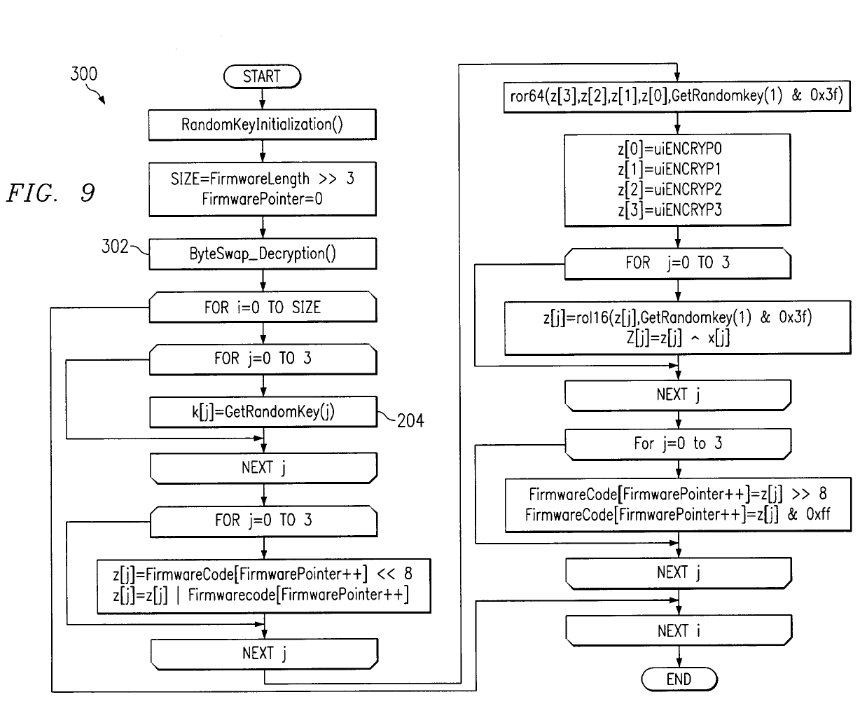

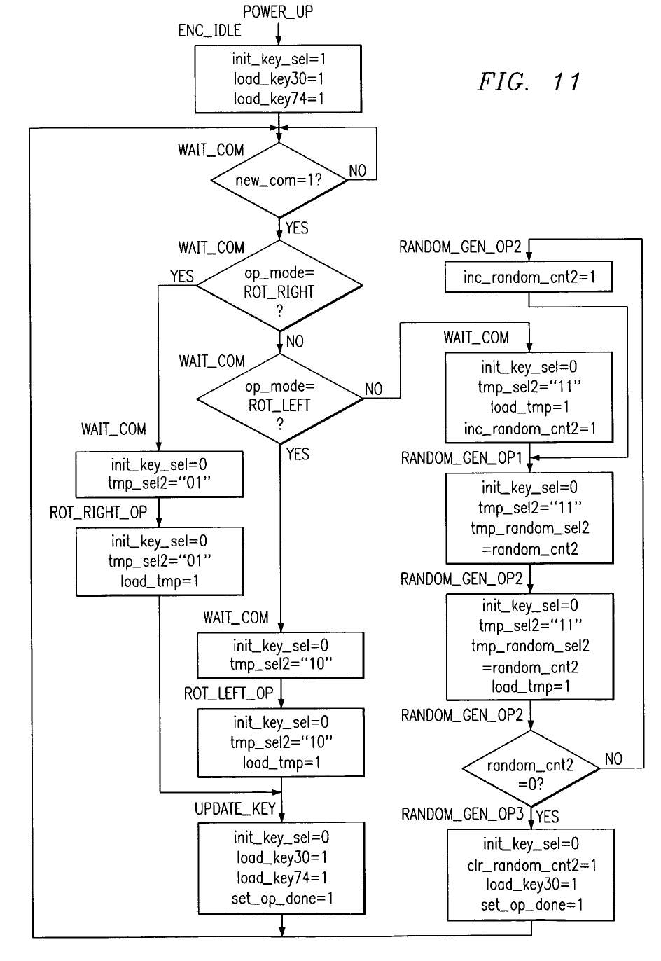

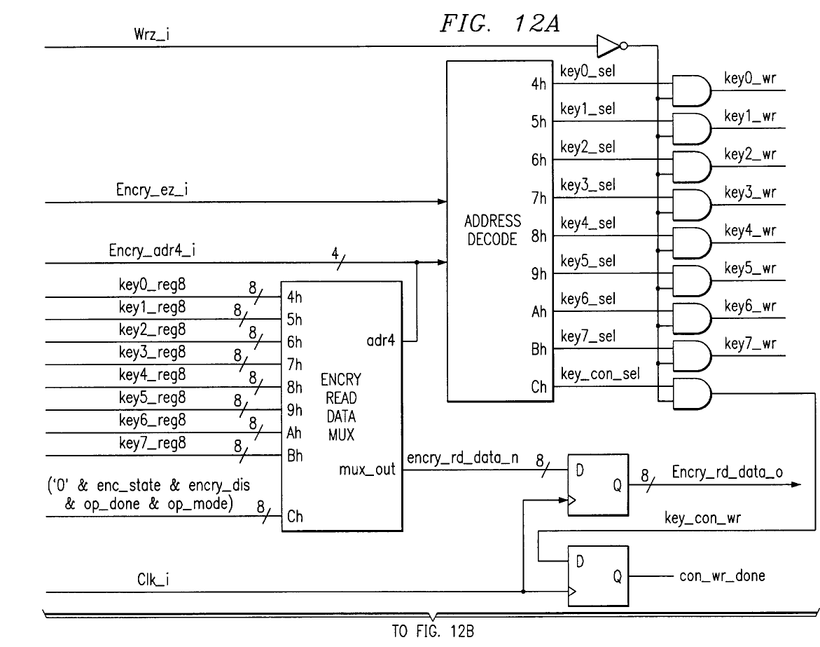

FIG. 9 is a flowchart depicting a method of decryption 300 that is suitable for use by the boot code encryption/decryption procedure 100 shown in FIG. 1. The method of decryption 300 also can be seen to employ a byte swapping algorithm, as seen in block 302. FIG. 5 is a flowchart depicting one method of decryption byte swapping that is suitable for use by the method of decryption shown in FIGS. 1 and 9.

Decryption method 300 can be seen to also employ the same method as that used by the encryption method, to retrieve the private random key as seen in block 204. The method for getting the random key shown in FIG. 7 is also suitable for use by the decryption method shown in FIGS. 1 and 9 respectively.

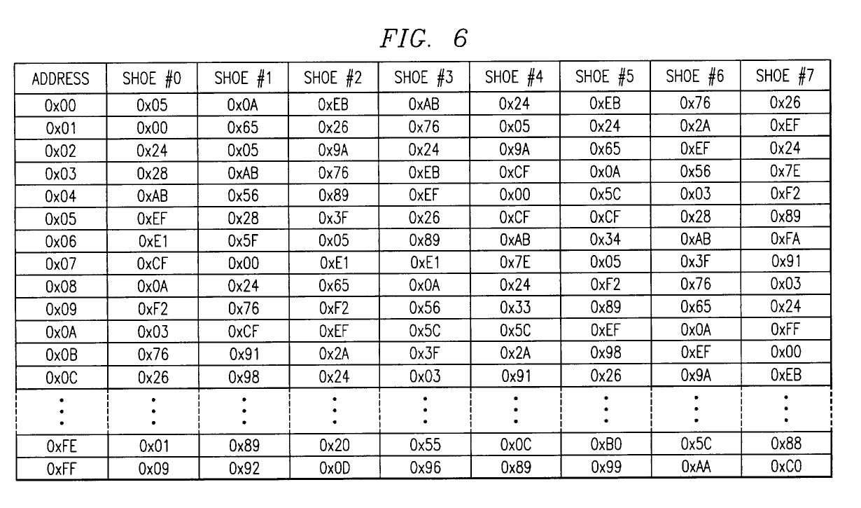

FIG. 6 illustrates eight shoes filled with encrypted data using the encryption methods discussed herein before with reference to the particular embodiments of the present invention. Each shoe is a byte array (column) used for byte swapping operation after the firmware is encryption. In summary explanation, once the on-chip ROM based encryption/decryption boot code 100 finishes the firmware download from the external on-board EEPROM or other like storage device, it initiates several fixed order encryption commands by writing to the encryption function control register discussed herein before. This register, in turn, initiates some hardware encryption operation to the 64-bit data using one of the three types of encryption: rotate 16-bit left or right and random key generation described in detail above. The result of the combined hardware and firmware encryption operation mechanism is the creation of a random, unique 128-bit data as the encryption key. The boot code 100 can use this key to encrypt the complete downloaded firmware in RAM and then write the encrypted version of firmware back to the controller's external on-board EEPROM or other like data storage device as shown in block 116. This process ensures that any firmware stored in the end product on-board EEPROM is shipped in a protected encrypted format.

With continued reference to FIG. 1, if an examination of the downloaded firmware indicates that encryption is not required, then a subsequent test is performed to determine if the downloaded firmware is already encrypted as shown in block 118. If the downloaded firmware is not already encrypted, then system control is immediately released to the downloaded firmware as shown in block 120. If, on the other hand, the downloaded firmware is already encrypted, then the random key initialization is again performed as seen in block 122, followed by a decryption procedure 300 to decrypt the already encrypted downloaded firmware as seen in block 124.

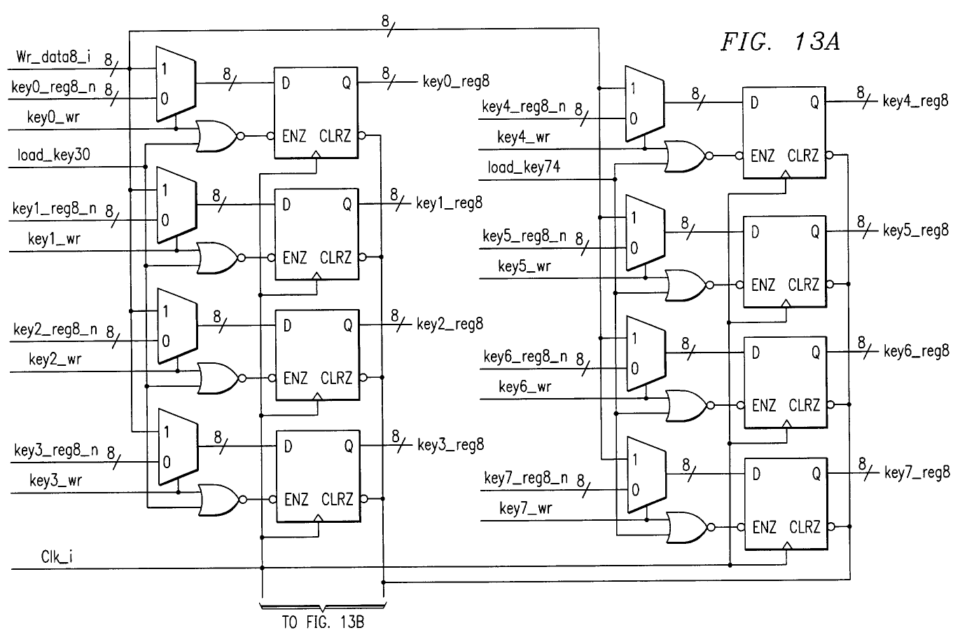

FIG. 11 is a flowchart depicting an encryption state machine corresponding to the method of encryption shown in FIG. 1 and described with reference to Tables 1 and 2 and FIGS. 1-10 herein before.

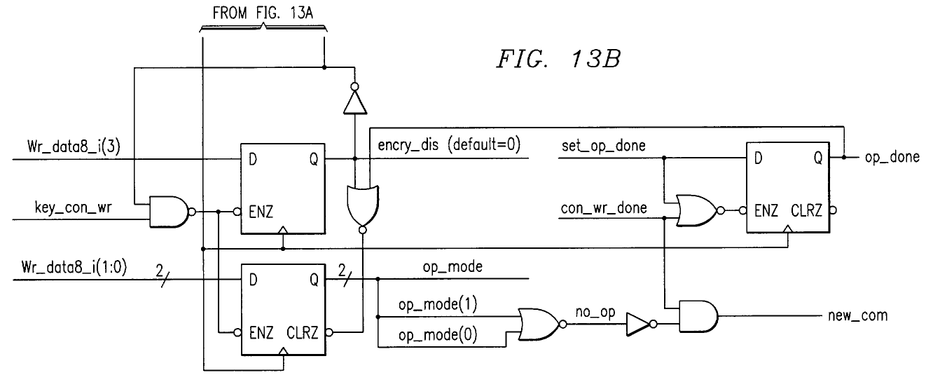

FIG. 12 is a schematic diagram illustrating encryption MCU address decode, read data mux, die ID scrambler, and key next value mux logic associated with the method of encryption discussed herein before with reference to FIGS. 1-11.

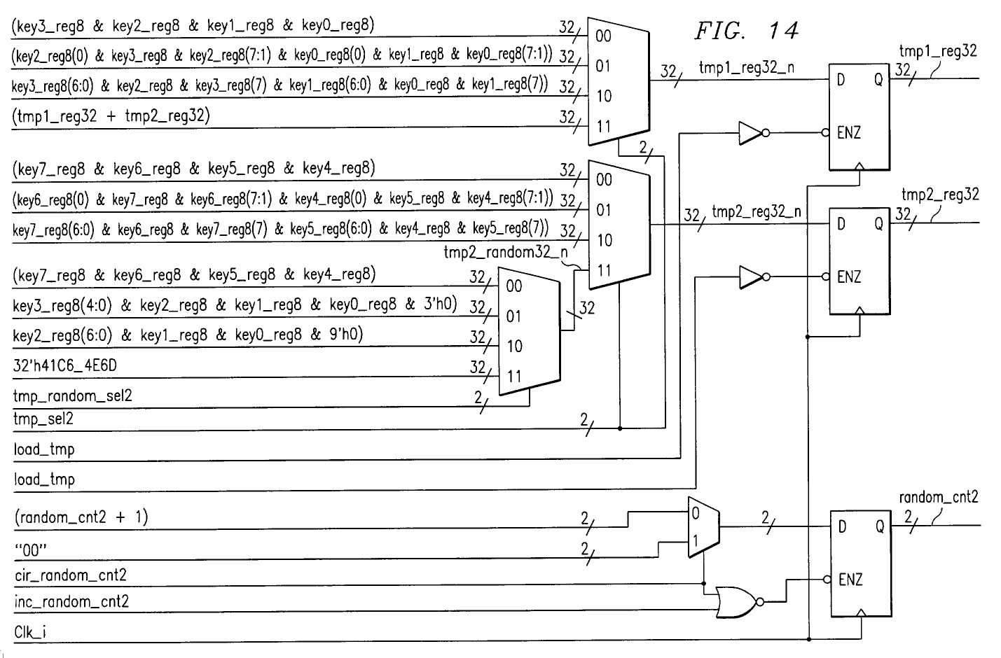

FIG. 13 is a schematic diagram illustrating encryption key registers and function control register update and clear logic associated with the method of encryption discussed herein before with reference to FIGS. 1-11.

FIG. 14 is a schematic diagram illustrating operation register logic and random operation mux select counter logic associated with the method of encryption discussed herein before with reference to FIGS. 1-11.

In summation, a solution has been described for encrypting off-chip firmware stored in an on-board storage device such as an EEPROM and that is downloaded to an on-chip storage device such as a RAM. The solution is unlike known solutions since the solution employs the use of software, hardware and a unique on-chip serial die ID number. While known solutions generally use two pairs of encryption keys for the IC chip vendor and the OEM end product vendor (public key and private key), the present solution instead creates an encryption key by itself with no person knowing the key value. Further, the present solution does not require additional software to generate an encrypted firmware image such as required by known solutions. Importantly, the encrypted firmware image created using the present solution is different for each individual end product that is shipped. In contrast, known solutions employ an encrypted firmware image that is identical for all products shipped by the same OEM, and can be decrypted with the same encryption key.

Since the encryption key generated in accordance with the present solution is created with the involvement of software, hardware and a 64-bit unique on-chip serial die ID number, the key changes from chip to chip; however remaining consistent for a particular end product. This technique makes possible, encryption and decryption of firmware downloaded into RAM, using a random number generator. Such use of a random number generator is not possible using known solutions, since the encryption key that is generated will be different for every power-up event.

Those skilled in the encryption art will readily appreciate that it is much more difficult to break the encryption key generated according to the principles of the present invention, than known solutions that generate encryption keys using purely a software or hardware solution. This extra level of protection is achieved since “no one knows the encryption key generated by a particular end product's encryption hardware and firmware”. In contrast, “some one knows the (public) key” using known encryption solutions.

In view of the above, it can be seen the present invention presents a significant advancement in the art of firmware data transfer techniques. Further, this invention has been described in considerable detail in order to provide those skilled in the data encryption art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. The encryption mechanism described herein before with reference to the particular embodiments of the invention, for example, is design independent. The same solution can therefore be applied in different applications and end products, such as digital signal processors, for example, so long as the end product utilizes on-chip code and off-chip firmware stored in an on-board data storage device such as an EEPROM.

What is claimed is:

1. A method of encrypting software, the method comprising the steps of:
providing a device comprising:
an integrated circuit including an on-chip data storage unit and an on-chip bootable encryption algorithm; and
an off-chip firmware;
activating the device and downloading software associated with the off-chip firmware into the on-chip data storage unit in response to the on-chip bootable encryption algorithm;
encrypting the downloaded software in response to the on-chip bootable encryption algorithm; and
uploading the encrypted software such that the software associated with the off-chip firmware is displaced with the encrypted software.

2. The method according to claim 1 wherein the step of encrypting the downloaded software in response to the on-chip bootable encryption algorithm comprises encrypting the downloaded software in response to a desired system of hardware logic, firmware, and a unique on-chip die identification number.

3. The method according to claim 1 wherein the step of encrypting the downloaded software in response to the on-chip bootable encryption algorithm comprises encrypting the downloaded software such that neither a public key nor a private key is required to decrypt the encrypted software.

4. The method according to claim 1 wherein the step of encrypting the downloaded software in response to the on-chip bootable encryption algorithm comprises encrypting the downloaded software such that an encrypted firmware image is generated that is different for each device.

5. The method according to claim 1 wherein the step of encrypting the downloaded software in response to the on-chip bootable encryption algorithm comprises generating a random key in response to a seed based on a unique on-chip die identification number associated with the integrated circuit.

6. The method according to claim 5 wherein the step of encrypting the downloaded software in response to the on-chip bootable encryption algorithm further comprises selectively rotating the random key right or left in response to a desired encryption function control register bit setting.

7. The method according to claim 6 wherein the step of encrypting the downloaded software in response to the on-chip bootable encryption algorithm further comprises byte swapping the downloaded data in response to the rotated random key.

8. A method of encrypting software, the method comprising the steps of:
downloading software associated with an off-chip firmware into an on-chip data storage unit in response to an on-chip bootable encryption algorithm;
encrypting the downloaded software in response to the on-chip bootable encryption algorithm; and
uploading the encrypted software such that the software associated with the off-chip firmware is displaced with the encrypted software.

9. The method according to claim 8 wherein the off-chip firmware, the on-chip data storage unit, and the on-chip bootable encryption algorithm comprise distinct portions of a common device.

10. The method according to claim 8 wherein the off-chip firmware is stored in an EEPROM.

11. The method according to claim 8 wherein the on-chip data storage unit comprises at least one device selected from the group consisting of random access memory (RAM), and read only memory (ROM).

12. The method according to claim 8 wherein the step of encrypting the downloaded software in response to the on-chip bootable encryption algorithm comprises encrypting the downloaded software in response to a predetermined system comprising hardware logic, firmware, and a unique on-chip die identification number.

13. The method according to claim 8 wherein the step of encrypting the downloaded software in response to the on-chip bootable encryption algorithm comprises encrypting the downloaded software such that neither a public key nor a private key is required to decrypt the encrypted software.

14. The method according to claim 8 wherein the step of encrypting the downloaded software in response to the on-chip bootable encryption algorithm comprises encrypting the downloaded software such that an encrypted firmware image is generated that is different for each chip.

15. The method according to claim 8 wherein the step of encrypting the downloaded software in response to the on-chip bootable encryption algorithm comprises generating a random key in response to a seed based on a unique on-chip die identification number associated with the chip.

16. The method according to claim 15 wherein the step of encrypting the downloaded software in response to the on-chip bootable encryption algorithm further comprises selectively rotating the random key right or left in response to a desired encryption function control register bit setting.

17. The method according to claim 16 wherein the step of encrypting the downloaded software in response to the on-chip bootable encryption algorithm further comprises byte swapping the downloaded data in response to the rotated random key.

18. A software encryption system comprising:
an integrated circuit including an on-chip data storage device and an on-chip bootable algorithmic encryption software; and
an off-chip firmware operational in response to the on-chip bootable algorithmic encryption software to download off-chip software into the on-chip data storage unit, encrypt the downloaded software in response to the on-chip bootable algorithmic software and upload the encrypted software such that pre-downloaded software associated with the off-chip firmware is displaced with the encrypted software.

19. The software encryption system according to claim 18 further comprising a plurality of encryption key registers configured to store a unique on-chip die identification number associated with the integrated circuit.

20. The software encryption system according to claim 19 further comprising an encryption function control register configured to control operation of the on-chip bootable algorithmic software such that the on-chip bootable algorithmic software operates to provide a desired data encryption technique.
